(19) United States
(12) Patent Application Publication
(10) Pub. No.: US 2015/0019449 A1
(43) Pub. Date: Jan. 15, 2015

(54) METHOD TO TRANSFER PERSONAL FINANCIAL INFORMATION AND OTHER HARD TO REPLACE DOCUMENTS TO A SELECTED RECIPIENT POST DEATH

(71) Applicant: Navin Murli Lalwani, West Orange, NJ (US)

(72) Inventor: Navin Murli Lalwani, West Orange, NJ (US)

(21) Appl. No.: 14/222,551

(22) Filed: Mar. 21, 2014

Related U.S. Application Data
(60) Provisional application No. 61/845,275, filed on Jul. 11, 2013.

(51) Int. Cl. G06Q 50/18; G06Q 10/10

(52) U.S. Cl. CPC G06Q 50/186; G06Q 10/10
USPC 705/312

(57) ABSTRACT

A safe, secure and reliable process allows a family member to select one or more loved ones who should be able to receive all the financial details, hard to replace documents, and other information of a person in case of an unfortunate sudden death. The system and methods surrounding this process can help avoid the various follow ups and errands that might be required with various agencies, such as banks, creditors, tax agents, insurance companies, and the like, to find all of the related and necessary information.

### CROSS-REFERENCE TO RELATED APPLICATIONS

This application claims the benefit of U.S. provisional patent application No. 61/845,275, filed Jul. 11, 2013, the contents of which are herein incorporated by reference.

### BACKGROUND OF THE INVENTION

The present invention relates to document and asset management systems and methods and, more particularly, to a method and process for transferring personal financial information, asset details, and hard to replace documents to one or more selected recipients post death.

Currently, many banks, financial institutions, and insurance companies retain billions of dollars in unclaimed assets. These and other investments often remain unclaimed because the beneficiaries of a deceased benefactor are unaware of the death and/or of the existence of the investment.

In an unfortunate case of a sudden death, the family or loved one has to go through the painful process of checking the person's personal belongings, such as wallets, cupboard drawers, and the like, to find any papers and documents which might provide any financial details. There are many documents, such as wills, property deeds and similar hard to replace documents, which are kept in banks or other places, but the user has no way to make sure these documents reach the family members after his or her death.

Moreover, natural calamities and other events, such as theft, fire, and the like, pose another risk to protect such hard to replace documents.

Currently, there is no way for a loved one, such as a wife, husband, partner, son, daughter, or the like, to find out about the financial details, such as bank accounts, insurance policy number, loans, stocks, trading accounts, and the like, if there is a sudden death of a family member.

As can be seen, there is a need for system and method for tracking and storing financial, asset and liability information as well as for storing important document, where an authorized user can access the data after the death of the registered user to view all of the pertinent information in one, easy to access and retrieve location.

### SUMMARY OF THE INVENTION

In one aspect of the present invention, a method to transfer personal data to a selected recipient post death comprises registering a user on a computerized system; prompting the registered user to enter data into the computerized system; uploading the data to a database of the computerized system; providing the registered user to link one or more information recipients to permit future access to the data after the registered user's death; and permitting access to the data by the information recipient after verification of the information recipient's identity and the registered user's death.

In another aspect of the present invention, a computer-implemented method, written as a programmable code and stored on a tangible computer readable medium comprises a registration module and a claim module, the registration module including the steps of registering a user on a computerized system; prompting the registered user to enter data into the computerized system; encrypting the data; uploading the encrypted data to a database of the computerized system; and providing the registered user to link one or more information recipients to permit future access to the data after the registered user's death; and the claim module including the steps of permitting access to the data by the information recipient after verification of the information recipient's identity and the registered user's death.

In a further aspect of the present invention, a computer-based data storage and information retrieval system comprises a user graphical user interface provided to a user to permit registration to the system; a data entry module allowing a user to enter or upload data; a database for storing the data entered by the user; and an information recipient graphical user interface provided to an information recipient to permit access to the data after verification of the information recipient's identity and the user's death.

These and other features, aspects and advantages of the present invention will become better understood with reference to the following drawings, description and claims.

### BRIEF DESCRIPTION OF THE DRAWINGS

FIG. 1 is an exemplary screen shot (graphical user interface (GUI)) of a site layout according to an exemplary embodiment of the present invention;

FIG. 2 is a flow chart showing a process of registering as a new user according to an exemplary embodiment of the present invention;

FIG. 3 is a flow chart showing the process where a information recipient can be validated to access the system to confirm a user's death and obtain access to appropriate documents and information;

FIG. 4 is an exemplary GUI showing an asset input screen, where a user can input and/or edit their assets;

FIG. 5 is an exemplary GUI showing a liability input screen, where a user can input and/or edit their liabilities;

FIG. 6 is an exemplary GUI showing an upload screen, where a user can upload or remove documents from the system;

FIG. 7 is an exemplary GUI showing a screen where information recipients (beneficiaries) can be added and/or updated; and

FIG. 8 shows the overall data flow in the system according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a safe, secure and reliable process where a family member can select one or more loved ones who should be able to receive all the financial details, hard to replace documents, and other information of a person in case of an unfortunate sudden death. The system and method of the present invention can help avoid the various follow ups and errands that might be required with various agencies, such as banks, creditors, tax agents, insurance companies, and the like, to find all of the related and necessary information.

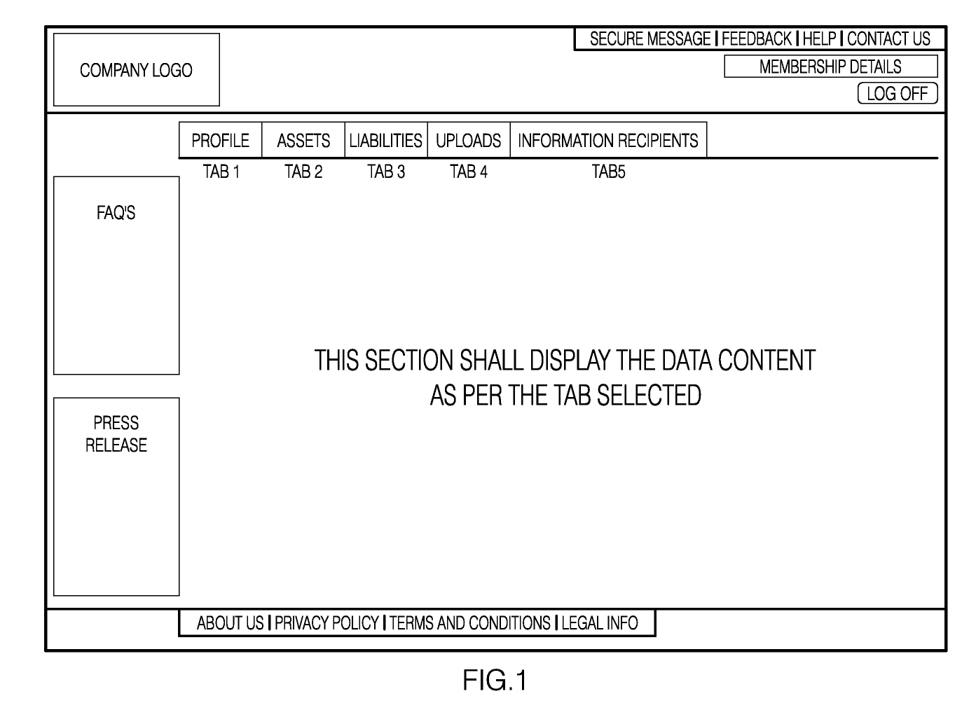

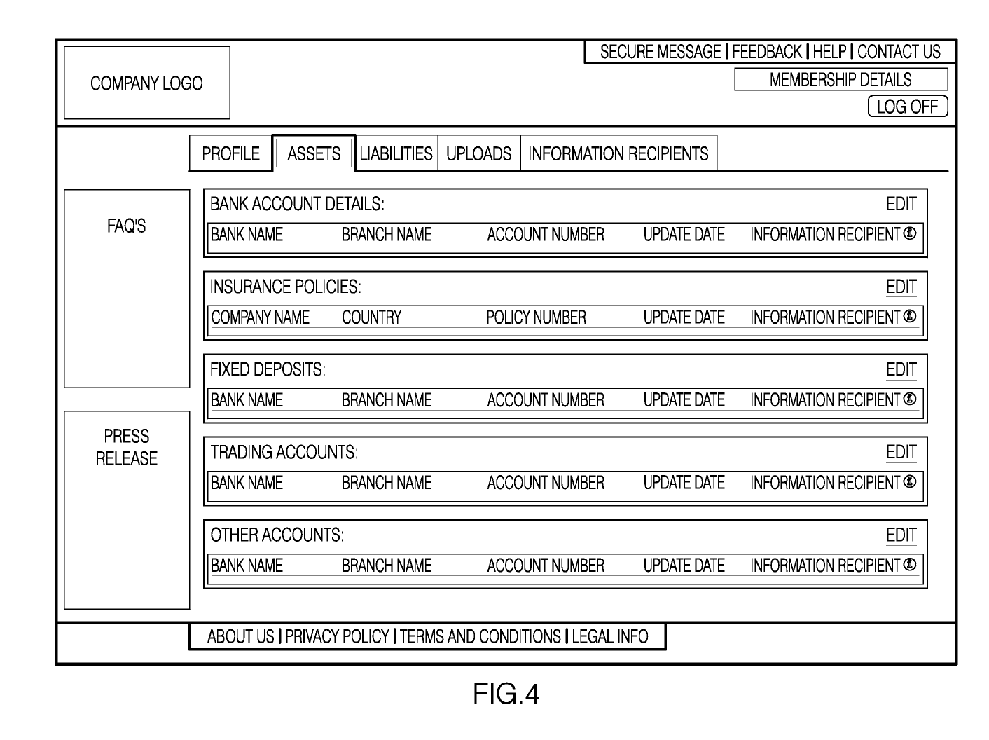

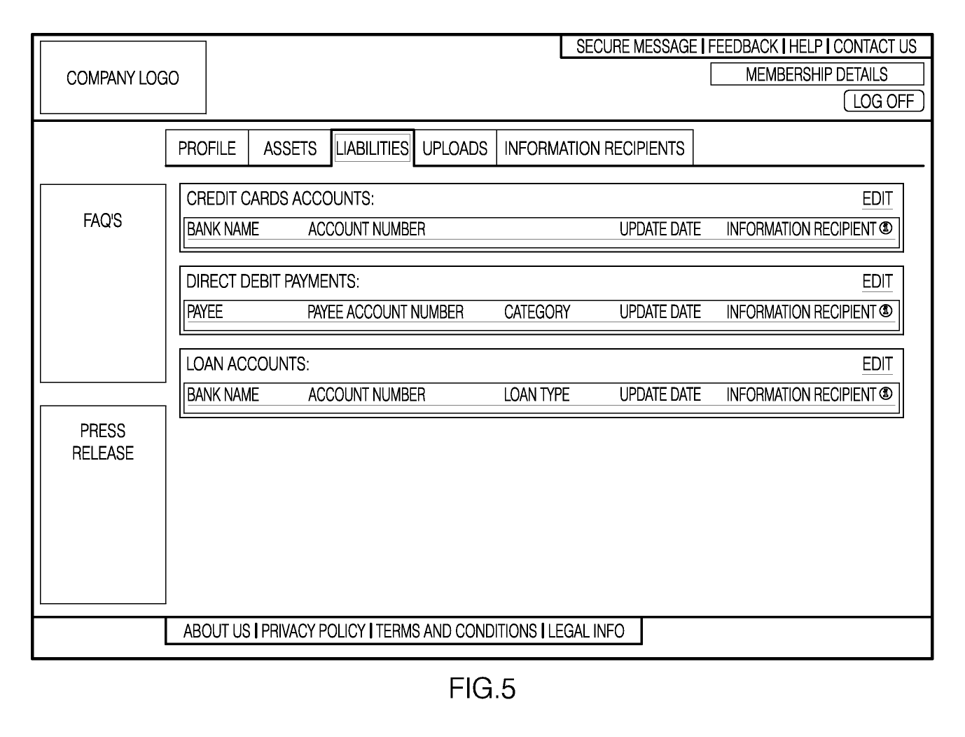

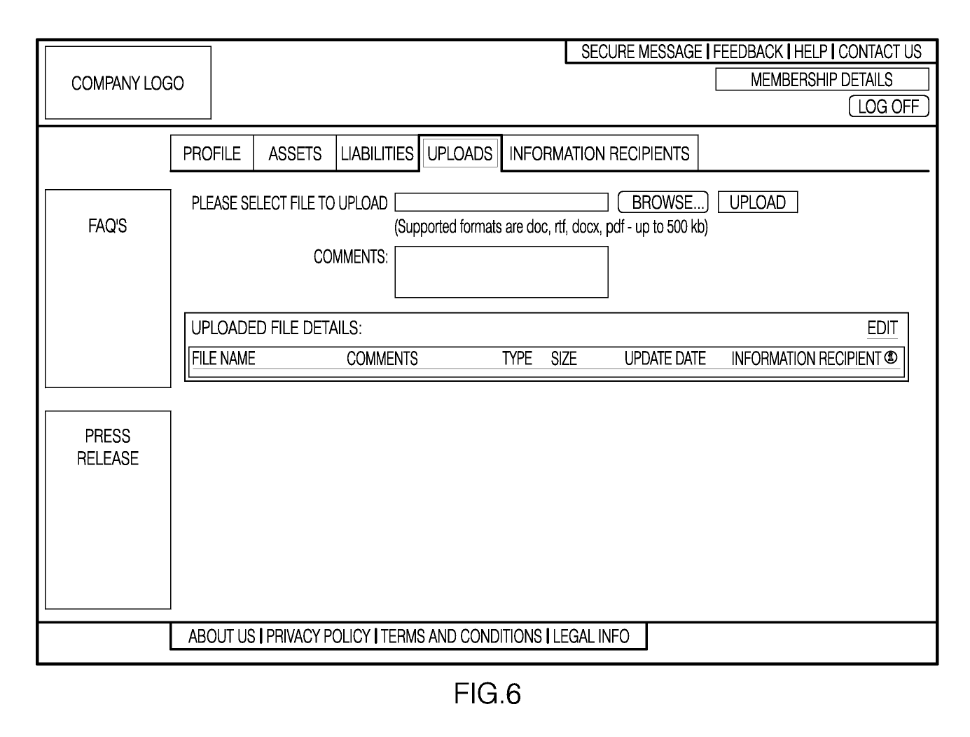

Referring now to FIGS. 1 through 8, a process according to an embodiment of the present invention is described below. This process may be implemented with a computer system, where a user can access the system of the present invention via a web-based interface, a software-based interface or the like. The data received by the system of the present invention can be stored in a database that can be encrypted and/or encoded with appropriate security to prevent unauthorized access to a user's personal information. In some embodiments, the data could be stored locally, by the user only, where the system of the present invention would access this data as needed. In other embodiments, the data may be stored on one or more servers or cloud-based systems or other data storing systems as may be known in the art.

The method of the present invention can be carried out, in an exemplary embodiment, by the process below. Of course, variations in the process are contemplated within the scope of the present invention.

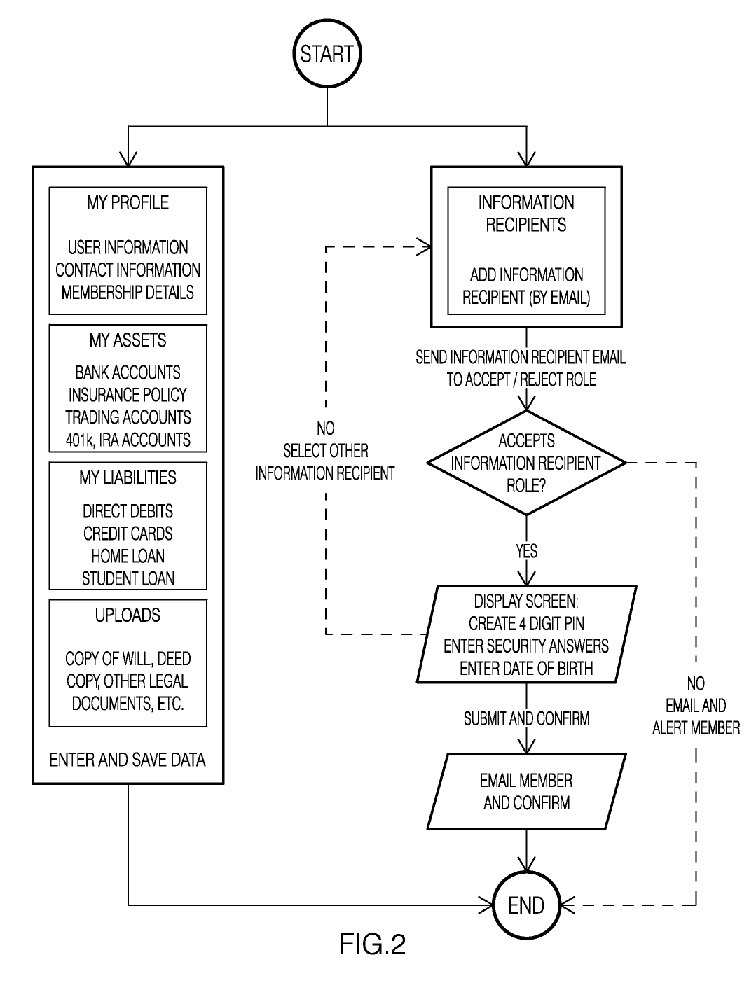

A new user can register (create a profile) himself using the GUI and updates all information, as shown in FIG. 2). The user can update all information for each section, including assets, liabilities, and document uploads, as shown in FIGS. 1, 4, 5 and 6.

The data can cover practically any data the user wishes to store. FIG. 1 shows exemplary tabs under which data may be stored. Specific examples of profile data include user details, user contact details, membership details and user preference settings. Specific examples of asset data include bank accounts, insurance policies, fixed deposits, trading accounts, stocks, bonds, retirement accounts, collectibles, art, jewelry, furnishings, and the like. Specific examples of liability account include credit cards, direct debit payments (such as utility bills, phone bills, car loan payments, homeowner's association fees, mortgages, magazine subscriptions, life insurance premiums, health insurance premiums, newspaper subscriptions, and the like), and loans (such as home loans, car loans, student loans, and the like). Specific examples of data uploads include important documents such as wills, property deeds, birth certificates, company documents, important bills, passport copies, and other hard to replace documents. Specific examples of information under the information recipients tab can include name, relationship, email, phone number, status (such as confirmed, pending, or the like), test a report (to test run a report that will be sent to the beneficiary), and action (to edit or delete information).

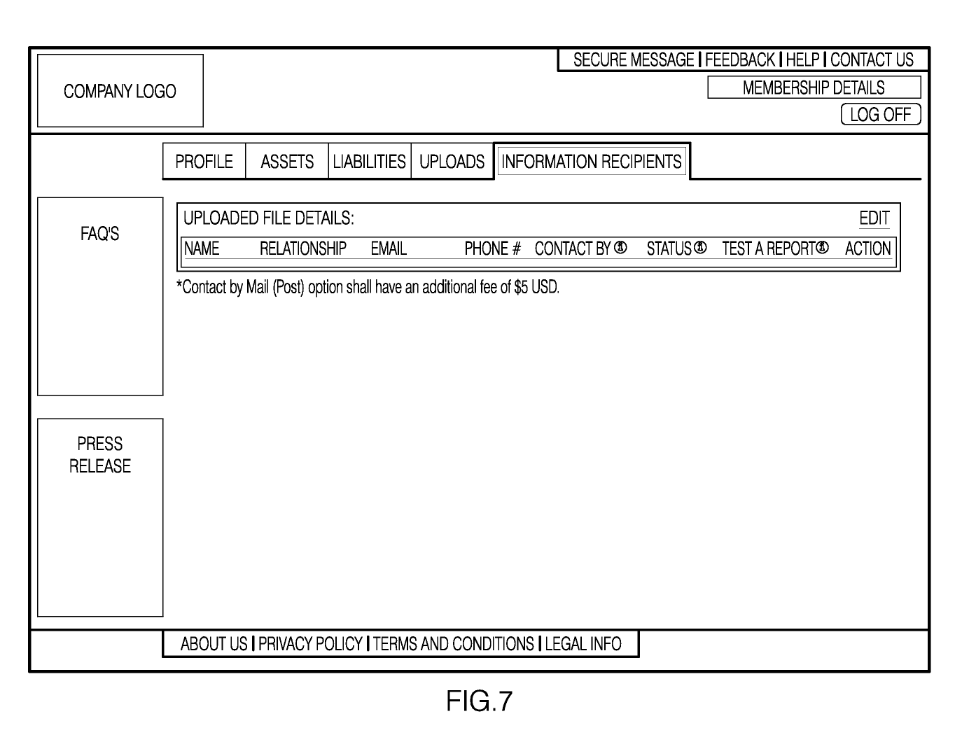

The user can then select one or more information recipients, as shown in FIG. 7. With this function the registered user can select multiple individuals who can receive the information after his or her death. The user can enter the first name, last name, email and phone number of the person he wishes to select as an information recipient. An email can be sent out to that selected information recipient requesting to “Accept” or “Reject” the information recipient role. If the selected information recipient “Accepts” the request, he/she shall be navigated to the new screen to create a 4 digit security PIN, two security questions and confirm his date of birth. Once completed, an email confirmation is sent to the registered user notifying that the information recipient has confirmed the request and an email is sent to the information recipient which describes the steps the information recipient needs to take when claiming all the information. If the selected information recipient “Rejects” the request, an email is sent to registered user notifying him/her of the rejection and requesting to select another person as an information recipient.

After the death of the user, an information recipient can submit a request for registered user's information. The information recipient can navigate to the website homepage (or access appropriate software and/or applications, or the like) and click on the “File a Claim” link to claim information of registered user. The information recipient can enter his/her first name, last name, email address, 4 digit PIN code, capcha security words and run a search. Based on the above search, if there is a registered user who has selected him/her as information recipient, system can display a message, such as a message saying “There is one matching user, to view the details please proceed with the security check and click on, for example, the “Send Code” button. Once clicked, the system can send a secure code to the information recipient email address for verification before displaying the user information. A secure code can be sent to the information recipient email address for verification. Once verified (the information recipient enters the code and click, for example, the “Verify Me” button, the name of the registered user(s) is displayed to the information recipient along with the link next to the registered user(s) to claim or request his/ her information details.

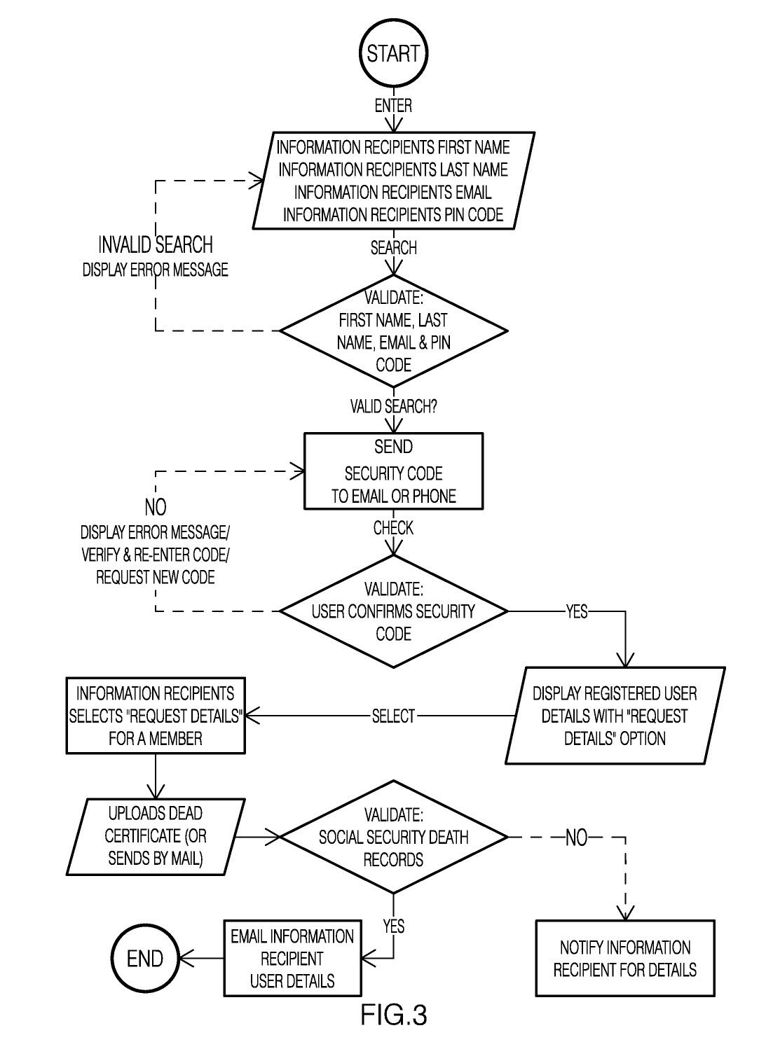

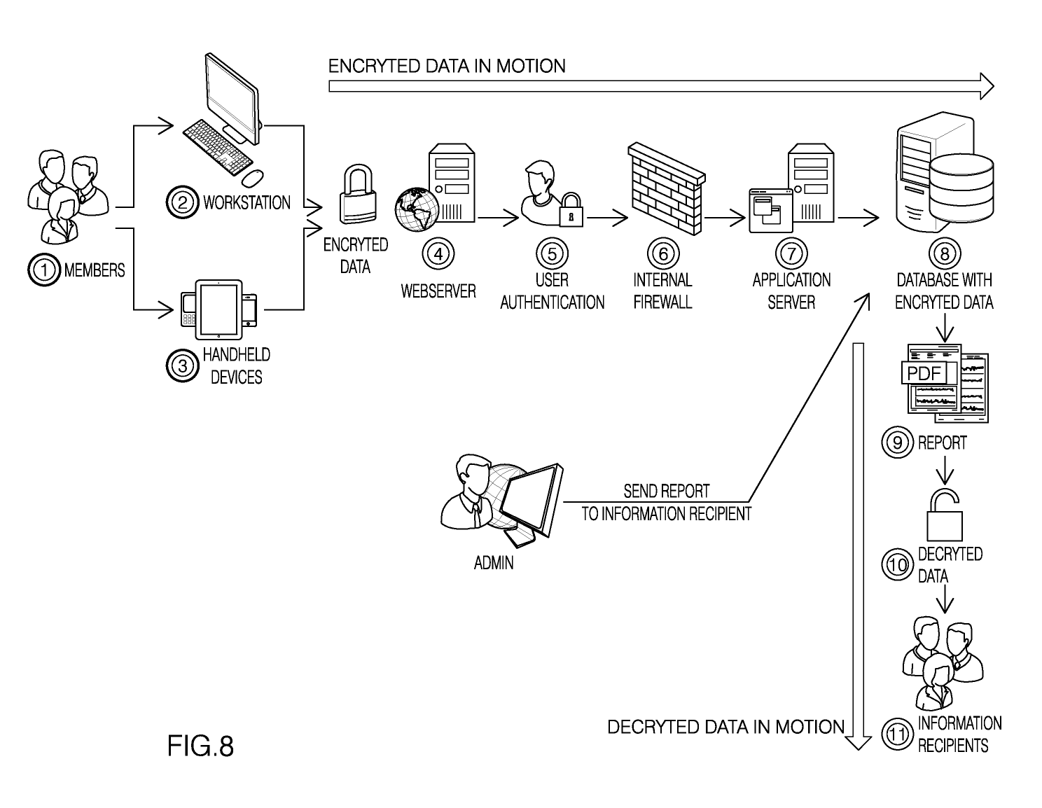

Once the information recipient clicks on the Submit link, system can ask the information recipient to upload a copy of a notarized death certificate. Post verification of the death certificate with the social security office and government agencies (done by back office staff), members details are sent to the information recipient in a pdf document format via email as shown in FIGS. 3 and 8.

Referring now specifically to FIG. 9, the application can utilize PHP's Mcrypt library and AES-256 algorithm to encrypt and decrypt the confidential user data that will be saved in the database. The cipher AES-256 is used among other places in TSL/SSL across the Internet and is considered among the top ciphers. In theory, it is not crackable since the combinations of keys are massive. This makes data highly secure in the database and, as an added layer of security, the secret keys make it even more secure as they are unknown to the end user, making it difficult to crack the same. Once users enter the information (such as Bank account numbers,

Insurance policy numbers, or the like), it is stored in the database in encrypted form using Rjindael and base64_encode algorithm along with keys to provide more security. This data is so secure that it is not even visible to the database administrator or the system administrator. The security keys are stored in a PHP file and are generated to decrypt the data only when the data is sent to the information recipient in an auto email mode. For example, once the user enters an account number as “11000001”, it is saved in the database as “jkasy678jkj#@24$989**67#” in encrypted form. This encrypted text is a combination of account number and keys.

Only the user who is the owner of that account number or the Information recipient (nominee of that user) will be able to view that decrypted information. No other user, visitor, system administrator, super users, database administrator, or the like, will be able to view that data on the site or in the database.

Post verification of the death certificate with the social security office or other government agencies (done by back office staff), the admin user/back office staff shall utilize the admin console to send the member information report to the information recipient. The member's details are sent to the information recipient in a pdf document format via auto email where the encrypted data “jkasy678jkj#@24$989**67#” is converted back to “11000001”. The encrypted data is decrypted with the unique secure key and sent out to the information recipient. Once sent, the same report is not only deleted from the temporary folder but also to make sure no other user can access the same file, the PDF file is protected with a PIN code which is the 4 digit PIN code of the Information Recipient.

It should be understood, of course, that the foregoing relates to exemplary embodiments of the invention and that modifications may be made without departing from the spirit and scope of the invention as set forth in the following claims.

What is claimed is:

1. A method to transfer personal data to a selected recipient post death, the method comprising:
registering a user on a computerized system;
prompting the registered user to enter data into the computerized system;
uploading the data to a database of the computerized system;
providing the registered user to link one or more information recipients to permit future access to the data after the registered user's death; and
permitting access to the data by the information recipient after verification of the information recipient's identity and the registered user's death.

2. The method of claim 1, further comprising uploading a death certificate to the computerized system for verification before access to the data is provided to the information recipient.

3. The method of claim 1, further comprising allowing a potential information recipient to enter their name and verification information to search to confirm that the potential information recipient is one of the one or more information recipients.

4. The method of claim 1, further comprising sending the data to the information recipient by email.

5. The method of claim 1, wherein the computerized system includes an internet-based graphical user interface for the user and the information recipient.

6. The method of claim 1, further comprising encrypting the data before saving the data on the database.

7. A computer-implemented method, written as a programmable code, stored on a tangible computer readable medium, the method comprising a registration module and a claim module
the registration module implementing the steps of
registering a user on a computerized system;
prompting the registered user to enter data into the computerized system;
encrypting the data;
uploading the encrypted data to a database of the computerized system; and
providing the registered user to link one or more information recipients to permit future access to the data after the registered user's death; and
the claim module implementing the steps of
permitting access to the data by the information recipient after verification of the information recipient's identity and the registered user's death.

8. The method of claim 7, wherein the claim module includes a step of uploading a death certificate of the registered user and verifying with death records.

9. The method of claim 7, further comprising a search module allowing a potential information recipient to enter their name and verification information to search to confirm that the potential information recipient is one of the one or more information recipients.

10. The method of claim 7, wherein the computerized system includes an internet-based graphical user interface for the user and the information recipient.

11. A computer-based data storage and information retrieval system comprising:
a user graphical user interface provided to a user to permit registration to the system;
a data entry module allowing a user to enter or upload data;
a database for storing the data entered by the user; and
an information recipient graphical user interface provided to an information recipient to permit access to the data after verification of the information recipient's identity and the user's death.

12. The system of claim 1, wherein the data is encrypted prior to storage in the database.

13. The system of claim 1, wherein the data stored in the database includes one or more information recipients linked to the user.
